(19) United States
(12) Patent Application Publication
(10) Pub. No.: US 2006/0220460 A1
(43) Pub. Date: Oct. 5, 2006

(54) Low voltage control module

(76) Inventors: James M. Grolmes, Antioch, IL (US); Kenneth M. Quinn, Chicago, IL (US)

Correspondence Address: JANSSON, SHUPE, MUNGER & ANTARAMIAN, LTD, 245 MAIN STREET, RACINE, WI, 53403, US

(21) Appl. No.: 11/095,016

(22) Filed: Mar. 31, 2005

(51) Int. Cl. H02J 1/00

(52) U.S. Cl. 307/30

(57) ABSTRACT

A low voltage controller includes a circuit board having first and second lengthwise ends and having a high voltage input proximate the first end and a high voltage output proximate the second end, the high voltage input for receiving an AC high voltage, a voltage conversion circuit disposed on the circuit board between the first and second ends and including a step-down transformer, the voltage conversion circuit being structured for converting the AC high voltage to at least one DC low voltage, a power terminal, at least one load switch disposed on the circuit board and activated by use of the at least one DC low voltage for controllably switching the AC high voltage from the power terminal to a first output of the high voltage output, and a hot wire providing an electrical connection for transferring the AC high voltage from the high voltage input to the power terminal.

### FIELD OF THE INVENTION

The invention is directed to a low voltage control module having an optimized configuration and, more particularly, to packaging of both low voltage control circuitry and associated high voltage load switching components in a single low profile package.

### BACKGROUND OF THE INVENTION

Fluorescent lighting fixtures have evolved in several aspects. For example, energy savings and weight reduction are some of the advantages of so-called “electronic” ballasts that have replaced traditional magnetic type ballasts. Compared with the conventional magnetic type ballasts, electronic ballasts also generate less heat and have a lower profile shape that allows a ballast compartment of a fluorescent fixture to have a corresponding shorter height.

A fluorescent lighting fixture may be installed in a hospital room, such as in a location over a patient bed, and a remote control switch unit may be provided in a location where it is convenient for a patient to control the operation of the fluorescent lighting fixture while lying in the hospital bed. Such a remote control switch is required to be operated with a DC low voltage for various reasons such as safety and related concerns. Therefore, a DC low voltage control signal is used to control a switching of AC high voltage to one or more electronic ballasts.

The DC low voltage control signals used for controlling the lighting adjacent a hospital bed are conventionally provided to a low voltage controller having a large size and shape, which limits the applications for such a low voltage controller.

### OBJECTS OF THE INVENTION

It is an object of the invention to provide an improved low voltage controller overcoming some of the problems and shortcomings of the prior art, including those referred to above.

Another object of the invention is to provide a low voltage controller in a single case having essentially the same dimensions as an electronic ballast, so that a ballast compartment and associated ballast mounting holes of a fluorescent lighting fixture may be utilized for placement of either the low voltage controller or the electronic ballast.

Another object of the invention is to provide a low voltage controller for a hospital room lighting fixture where installation efficiency is optimized.

Still another object of the invention is to provide a low voltage controller for fluorescent lighting fixtures where essential functionality is maintained while minimizing the profile of the controller.

Yet another object of the invention is to provide a low voltage controller adaptable for being configured to implement a variety of sequential and/or combinatorial logic applications.

Another object of the invention is to provide a low voltage controller having a single low profile package and adapted for receiving and controllably switching 277 VAC while also converting the received 277 VAC to DC low voltages for the control of the switching.

Another object of the invention is to provide a low voltage controller able to be configured for operation in various low voltage master/slave and/or timer applications.

These and other important objects will be apparent from the descriptions that follow.

### SUMMARY OF THE INVENTION

According to an aspect of the invention, a low voltage controller includes a circuit board having first and second lengthwise ends and having a high voltage input proximate the first end and a high voltage output proximate the second end, the high voltage input adapted for receiving an AC high voltage. Such a controller also has a voltage conversion circuit disposed on the circuit board between the first and second ends and including a step-down transformer, the voltage conversion circuit being structured for converting the AC high voltage to at least one DC low voltage. The controller also has a power terminal, at least one load switch disposed on the circuit board and activated by use of the at least one DC low voltage for controllably switching the AC high voltage from the power terminal to a first output of the high voltage output, and a hot wire providing an electrical connection for transferring the AC high voltage from the high voltage input to the power terminal.

According to another aspect of the invention, a low voltage controller for switching a high voltage load includes a case having approximate dimensions of 9.5 inches overall length, 1.72 inches width, and 1.14 inches height, the case having a mounting location proximate each lengthwise end and an approximate distance of 8.91 inches between the mounting locations. Such a controller also has a circuit board disposed within the case, an input for receiving a first AC high voltage, a step-down transformer mounted on the circuit board and structured for stepping a second AC high voltage down to an AC low voltage, the second AC high voltage being obtained from the first AC high voltage, a voltage converter mounted on the circuit board and operative to convert the AC low voltage to a DC low voltage, a relay for on/off switching of the first AC high voltage to an external load, and a control circuit powered by the DC low voltage, having a control input structured for obtaining a DC low voltage control signal, and structured for controlling the on/off switching of the relay based on the DC low voltage control signal.

As a result of various implementations of the invention, an improved low voltage controller for switching high voltage to external loads overcomes certain problems of the prior art.

The foregoing summary does not limit the invention, which is instead defined by the attached claims.

### BRIEF DESCRIPTION OF THE DRAWING FIGURES

FIG. 1 is a perspective view of a low voltage controller according to an exemplary embodiment of the invention.

FIG. 2 is an exploded sub-assembly view of the low voltage controller of FIG. 1, having a label for the controller's top surface.

FIG. 3 is a top view of a circuit board of the low voltage controller of FIG. 1, showing approximate component placement thereon.

FIG. 4 is a top view of the low voltage controller of FIG. 1, showing mounting dimensions.

FIG. 5A is a front view of the low voltage controller of FIG. 1, showing additional dimensions of a case; FIG. 5B is an end view of the low voltage controller of FIG. 1, showing a width and height dimension thereof.

FIG. 6 is a schematic diagram for a low voltage control circuit according to an exemplary embodiment of the invention.

FIG. 7 is a high voltage input section of a low voltage control circuit according to an exemplary embodiment of the invention.

FIG. 8 is a highly schematic view of a low voltage controller, where a low voltage section is bookended by high voltage sections, according to an exemplary embodiment of the invention.

FIG. 9 is a high voltage input adapter for a low voltage controller according to an exemplary embodiment of the invention.

FIG. 10A is a schematic view of a low voltage controller as part of a system having low voltage control switches, a high voltage input, and switched high voltage loads connected to output outputs of the low voltage controller, according to an exemplary embodiment of the invention; FIG. 10B is a state logic table for one of the low voltage control switches of FIG. 10A; FIG. 10C is a state logic table for another one of the low voltage control switches of FIG. 10A; and, FIG. 10D is a state logic table for yet another one of the low voltage control switches of FIG. 10A.

FIG. 11 is a top parts layout for a circuit board of a low voltage controller, according to an exemplary embodiment of the invention.

FIG. 12 is an electrical schematic diagram of a circuit of a low voltage controller, according to an exemplary embodiment of the invention.

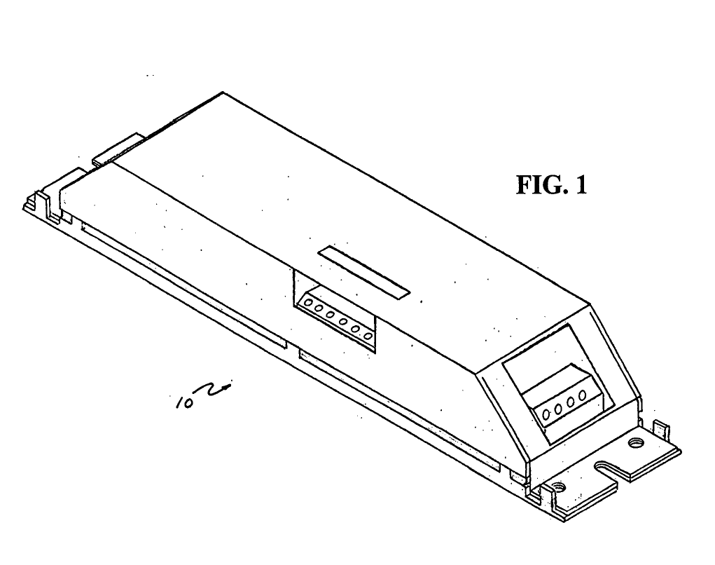

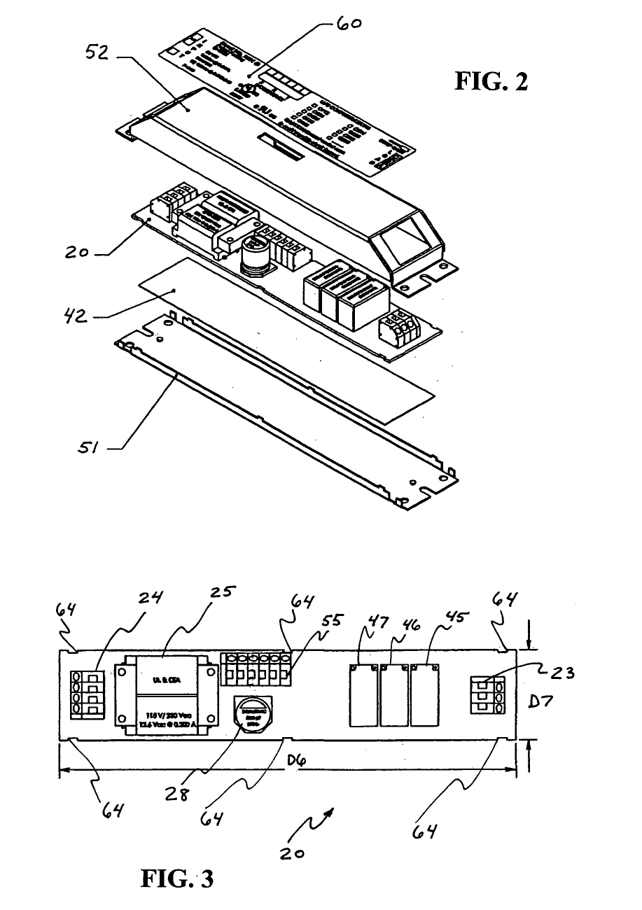

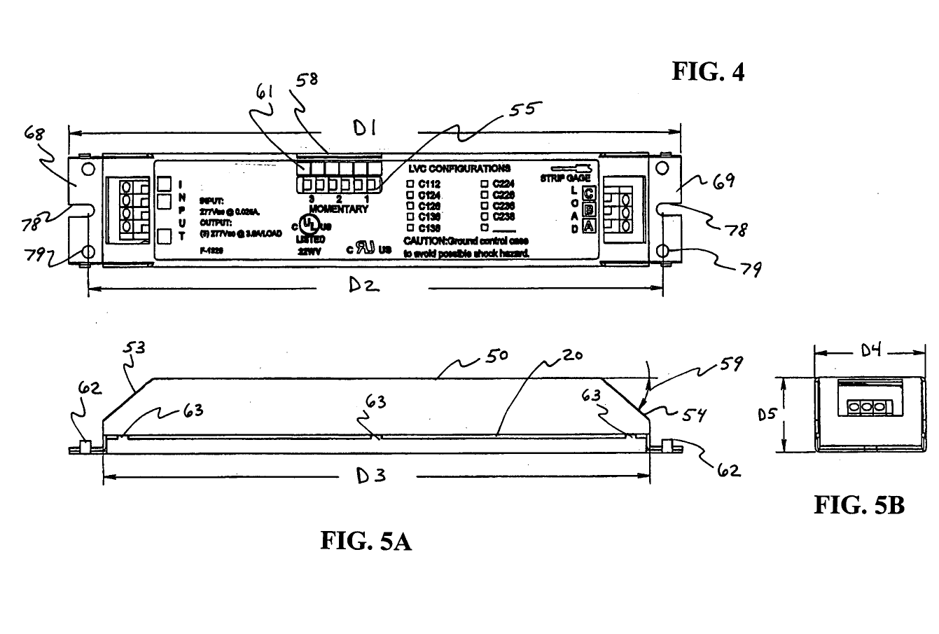

### DETAILED DESCRIPTION OF PREFERRED EMBODIMENTS

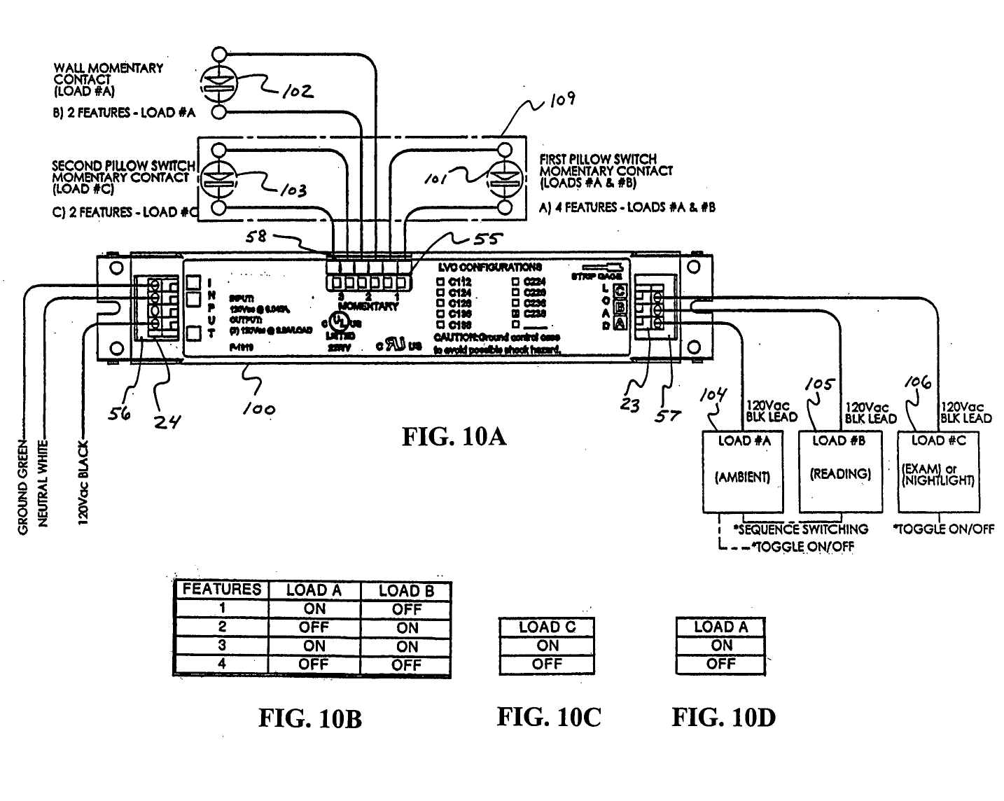

FIGS. 10D show a low voltage controller (LVC) 10 and an LVC 100 according to exemplary embodiments of the invention. LVC 10 includes a circuit board 20, an insulation sheet 42, a case bottom 51, a case top 52, and a top label 60.

Circuit board 20 has a two-sided circuit pattern configuration with conductive through holes (“vias”) connecting selected circuit traces of the respective top and bottom sides of circuit board 20. Circuit board 20 has a first high voltage section 21 that includes an input terminal block 24 and a step-down transformer 25. Step-down transformer 25 at its isolated primary side receives a high voltage from input terminal block 24, such as 120 VAC or 230/240 VAC and steps the high voltage down to a low voltage AC. An exemplary step-down transformer of a preferred embodiment is a model SPW-3051 available from Prem Magnetics, Inc. of McHenry, Ill.

As shown, input terminal block 24 receives an AC line voltage and feeds same to step-down transformer 25. A four-wire connection is provided for a hot, neutral, and ground along with a spare terminal. The hot lead is also provided to a hot buss at the second high voltage section 22 via a hot wire 40. Hot wire 40 is preferably an 18 AWG stranded wire having insulation layer(s) with a suitable high voltage rating and a high strength jacket for abrasion resistance. The secondary of transformer 25 is connected to a rectifier diode bridge 27, and a metal oxide varistor 26 is connected in parallel with the transformer secondary voltage for surge suppression, for example preventing a voltage spike from erasing the internal program of the microcontroller 70. The DC side of rectifier bridge 27 is connected in parallel with a filter capacitor 28 for reducing ripple. The filtered DC voltage from rectifier bridge 26 is then fed to a first voltage regulator 32, for example a device having an industry standard number 7812 and providing a 12 VDC output. This 12 VDC voltage is provided to twelve volt buss 34 for feeding the 12 VDC to a second voltage regulator 33 and to one respective side of each of three relay coils 35, 36, 37. Second voltage regulator 33 is preferably a device having an industry standard number 7805 and providing a 5 VDC output to a five volt buss 30 for feeding each of three switch loops M1, M2, M3 and for supplying power to microcontroller 70.

Relay coils 35, 36, 37 are each provided with a respective diode 87, 88, 89 in parallel, and are each activated with a respective relay driver transistor 84, 85, 86. Diodes 87, 88, 89 may be chosen, for example, as an industry part number DL4003MSCT or equivalent, and driver transistors 84, 85, 86 are preferably NPN general purpose switching transistors such as an industry part number MMBT3904 or equivalent. Diodes 81, 82, 83 are respectively provided between the individual switch outputs GP3, GP4, GP5 of microprocessor 70 and the corresponding bases of driver transistors 84, 85, 86, assuring that the turn-on voltage for such transistors is at a predetermined level. A suitable diode device for such application has an industry part number MMBD914. Activation of relay coils 35, 36, 37 respectively closes the normally-open relay contacts 65, 66, 67 of relays 45, 46, 47. Accordingly, relays 45, 46, 47 may be referred to herein simply as switches S1, S2, and S3, respectively. Closure of S1, S2, and/or S3 passes the AC high voltage from AC high voltage buss 29 as respective load signals A, B, and/or C to external loads.

The unique aggregate of individual packaging optimizations within the LVC of the present invention allows such LVC to be packaged within a case 50 having approximate dimensions of 9.5 inches overall length D1, 1.72 inches width D4, and 1.14 inches height D5, which corresponds to the industry standard size of an electronic ballast. As a result, the packaging of the LVC may be intended to match the corresponding standard 8.906 inch to 9.000 inch mounting centers of an electronic ballast. Case 50 therefore has an approximate distance of 8.91 inches (D2) between the mounting locations. The width and height of the LVC is minimized, for example, to an extent that the appropriate Underwriter's Laboratories (UL) specifications (e.g., clearance distance (through air) for an exposed high voltage) are satisfied. For example, when a 277 VAC voltage is being used as the high voltage, UL specification 60601-1 must be considered, whereby Table XVI requires a DI/RI clearance of 7.0 mm (0.276 inch). In particular, circuit board 20 is designed to accommodate 277 VAC by positioning each of the relay contacts of relays 45, 46, 47, the hot terminal(s) of input terminal block 24, the terminals of output terminal block 23, the hot primary terminals of step-down transformer 25, and the exposed end terminations of hot wire 40 a specified safe distance from other components and from any adjacent conductive surface such as case 50. The unique combination of packaging allows circuit board 20 to be formed with a nominal length D6 of 8.375 inches and a width D7 of 1.680 inches. In general, as the high voltage increases, the trace spacing for exposed high voltage must be correspondingly wider. Therefore, dimensions may be smaller than for the present example when the high voltage is 120 VAC.

LVC case 50 provides easy access for the quick termination of connection wires while still maintaining a minimum UL safety requirement for an Articulate Probe. Such Articulate Probe refers to a mechanical finger that tests for accessibility to live current-carrying devices—metal case components, vias, solder points, and component leads. Case 50 includes openings 56, 57 that provide for the access to respective connectors 24, 23 while complying with the UL Articulate Probe specification. Openings 56, 57 are respectively formed on ends 53, 54, where ends 53, 54 are each mitered at approximately 40 degrees from vertical, as indicated with reference character 59. As a result of such mitering, openings 56, 57 provide windows that are convenient for installing and un-installing connection wires, thereby saving time for assembly and maintenance while providing additional room for routing wires. A side window 58 is provided for access to low voltage terminal block 55. Side window 58 has a bar 61 across the top surface of case top 52 to prevent the Articulate Probe from contacting DC filtering capacitor 28 located adjacent terminal block 55. Windows 56, 57, 58 are designed to prevent damage to any wires passing therethrough. Top cover 52 is preferably formed of 18 gage galvanized metal in order to meet the UL requirements of minimum thickness of metal (0.032 inch).

Case 50 has a bottom plate 51 fabricated with a minimum thickness (height) necessary for supporting circuit board 20 when PCB 20 is loaded with surface mount components, and voltage regulators 32, 33, on its bottom side. In other words, bottom plate 51 may be formed using material thinner than that used in forming top cover 52. Voltage regulators 32, 33 of the preferred embodiment are the thickest components and therefore determine the board support height, along with insulation sheet 42. Insulation sheet 42 may be any suitable high voltage insulator, such as a 0.010 inch thick sheet of NOMEX type insulation paper or similar equivalent such as plastic. As a result, a board support height of a preferred embodiment is about 0.225 inch. Bottom plate 51 includes two half shears for locating the insulation sheet 42 while maintaining a structure where there are no openings to the bottom of circuit board 20. Bottom plate 51 has, respectively proximate each of its four comers, four fold-over tabs 62 for securing top cover 52 to bottom plate 51. At end portions 68, 69, top and bottom covers 52, 51 are each formed to include respective mounting slots 78 and holes 79 that align on top of one another when case 50 is assembled, the end portions 68, 69 each being defined by abutting and essentially parallel surfaces of top and bottom portions 52, 51. In addition, bottom plate 51 has six interlocking tabs 63 that engage corresponding notches 64 formed along the perimeter of circuit board 20, whereby circuit board 20 is prevented from movement. Top cover 52 abuts the top side of circuit board 20, thereby sandwiching circuit board 20 between top cover 52 and case bottom 51. In alternative embodiments, top and bottom portions of a case may be formed to continuously abut one another along respective perimeter portions rather than having a PCB-sandwiching space therebetween.

Label 60 is placed on top cover 52 for identifying the manufacturer, part number, operating characteristics, compliance listing and recognition markings, and wiring configurations. The termination points for connection of AC line voltage, external control switch loops, and high voltage load outputs are also identified. Different background colors may be used on respective versions of label 60 for identifying to an installer the particular model of low voltage controller, thereby assuring correct installation in an easy manner. For example, a light blue color may be used for identifying a 120 VAC LVC and a light pink color may be used for identifying a 240/277 VAC LVC, etc.

Relays 45, 46, 47 in a preferred embodiment are single pole devices that are used for switching only the AC hot lead to the various load(s). This is because of the UL spacing requirement for 277 VAC circuits. In other words, a gap spacing requirement of approximately 12 mm (˜0.500 inch) proscribes a use of a double pole device for switching both the hot and neutral lines when 277 VAC is being switched. Therefore, for a 277 VAC application, the neutral (white) wire bypasses the LVC and is typically connected directly to the load(s). However, with other AC high voltages such as 120/230 VAC, such a double pole relay may be used in various embodiments for switching both a 120 VAC hot lead as well as neutral. Relays 45, 46, 47 are preferably rated for switching 10 Amps and may be relays having an industry part number 845HN-1A-S or similar equivalent. The horsepower rating of a chosen relay should be large enough to account for any inrush current of a particular load. Depending on a type of load and high voltage being switched, it is possible to use devices other than relays for controllably switching the high voltage. However, typical SCR, triac, or transistor devices are unacceptable because they fail to provide the necessary UL spacing between high voltage and low voltage. In addition, an SCR having a current rating of approximately 10 Amps would be impractical, and a power MOSFET, for example, could be destroyed by static voltages. Therefore, in order to meet the UL requirements (e.g., creepage, spacing) for a high voltage switch of a low voltage controller, for a single-package configuration intended for use in a hospital, a relay is highly preferred over alternative high voltage switching devices. By way of example, an inrush current for an electronic ballast load may be as much as 50 A, but the duration of the corresponding current spike may be only 20 microseconds, so that by the time the relay contact closes, the excess current has already been absorbed and operation has settled at a steady state current of three to six amps. Transistors 84, 85, 86 and relays 45, 46, 47 are preferably selected to have a high switching speed.

In a preferred application, a low voltage controller is provided that effects an intelligent module linking a human interface with luminaire ballasts. The human interface may operate at a low voltage and very low current, for example, a 5 volts DC loop through a switch at 200 mA, which is suitable for use in a pillow switch located in close proximity to a hospital bed. For supplying the pillow switch with such low levels of electricity, LVC 10 includes a 5 VDC voltage fed to a microcontroller 70 and to a 5 VDC buss 30 for feeding individual switch(es) of the remote pillow switch. The 200 mA current is maintained for each of three external switch loops. For example, a switch loop M1 has a pair of terminals on switch terminal block 55, where one terminal is connected to 5 VDC buss 30 and the other terminal is connected to the GP0 pin of microcontroller 70 via series resistor 72. A capacitor 39 is connected between such other terminal and ground to assure that the switch input to GP0 is immune from noise. A biasing resistor 75 is connected between pin GP0 and ground to provide additional stability and a suitable voltage level to the switch input. The combination of resistors 72, 75, the impedance of the external M1 switch loop, and the input impedance of the GP0 connection establishes the nominal 200 mA M1 switch loop current at 5 VDC. In this example, a similar arrangement is provided for the M2 switch loop, whereby switch loop M2 has a pair of terminals on switch terminal block 55, with one terminal being connected to 5 VDC buss 30 and the other terminal being connected to the GP1 pin of microcontroller 70 via series resistor 71. A capacitor 44 is connected between such other terminal and ground to assure that the switch input to GP1 is immune from noise. A biasing resistor 74 is connected between pin GP1 and ground to provide additional stability and a suitable voltage level to the switch input. The combination of resistors 71, 74, the impedance of the external M2 switch loop, and the input impedance of the GP1 connection establishes the nominal 200 mA M2 switch loop current at 5 VDC. Finally, a switch loop M3 has a pair of terminals on switch terminal block 55, where one terminal is connected to 5 VDC buss 30 and the other terminal is connected to the GP3 pin of microcontroller 70 via series resistor 73. A capacitor 43 is connected between such other terminal and ground to assure that the switch input to GP3 is immune from noise. A biasing resistor 76 is connected between pin GP3 and ground to provide additional stability and a suitable voltage level to the switch input. The combination of resistors 73, 76, the impedance of the external M3 switch loop, and the input impedance of the GP3 connection establishes the nominal 200 mA M3 switch loop current at 5 VDC. The various capacitors and resistors for each switch loop are selected for preventing false switching and false triggering.

There is typically a limit on the length of the switch loops M1, M2, M3. For example, when 18 AWG wire is being used and such wire has a length of 300 feet, approximately twelve percent of the 5 VDC voltage is dissipated in the wiring. It is important to keep the voltage level above 2.6 VDC in order to maintain reliable operation of the switch(es) in cooperation with PIC processor 70.

When a switching event occurs in one of the switch loops M1, M2, M3, microcontroller 70 detects such event and acts according to a logic programmed therein. For example, a programmed logic within microcontroller can be a combinatorial or sequential logic, and can be implemented along with various timer functions. One exemplary sequential logic may include implementing the four states of a well-known binary truth table, such as that shown in the table of FIG. 10B, when it is desired to provide the ability to sequentially turn two loads off, turn only one load on, turn only the other load on, and turn both loads on, for successive activations of a momentary contact switch in a single switch loop. One exemplary combinatorial logic may include three switch loops, where a switch activation in a first switch loop turns on/off a first load, a switch activation in a second switch loop turns on/off a second load, and where a switch activation in a third switch loop locks-out the first and second loops, thereby toggling between an enabling and a disabling of the functions of the first and second switch loops. One exemplary timer application is addressed to a scenario where it is desired to ignore a second or successive activation of a switch event in a switch loop for a predetermined time, such as for accommodating a situation where a person might repeatedly toggle a wall switch. In such a case, the microcontroller is programmed to time out after a first switch event before being able to accept a second switch event as an input, thereby ignoring the repeated toggling. Many other sequential, combinatorial, and/or timer applications are possible and some possible applications are described further herein.

The control circuit of the low voltage controller 10 may include internal logic that allows a chosen switching or chosen switch pattern of the DC external control switches M1, M2, and/or M3 to act as an override signal for disabling the load switch(es) when the override signal is obtained. For example, many types of master/slave configurations may be implemented. In one example, a parental type logic may be programmed into PIC chip 70 so that a switch activation at a nurse's station disables a patient's bed switches until, for example, the nurse's switch is pressed a second time. This and similar override applications, including the use of an internal timer for re-enabling the load switch after a predetermined time, are discussed further below.

Microcontroller 70 in a preferred embodiment is a Programmed Integrated Circuit (PIC) available from Microchip Technology, Inc. and has a part number PIC12F629ISN. Among the multitude of structures in such a device is an internal FLASH program memory, an SRAM data memory, a EEPROM memory, an internal 4 MHz oscillator/clock, timers, internal electrostatic damage (ESD) protection, etc. In addition, the PIC device provides for high current sink/source capability, field re-programmability, bi-directional I/O, fast response time, a number of protection features, etc. An LVC may be optionally adapted for field programming the PIC 70, such as re-programming internal logic by applying an over-voltage to selected pins (e.g., Vpp) of microcontroller 70, by changing from one preset operation mode to another, etc.

As shown in FIG. 10A, an LVC 100 is adapted for receiving and switching a 120 VAC line voltage at input terminal block 24 and controllably switching the 120 VAC hot voltage to any of three loads 104, 105, 106. In this example, loads 104, 105, 106 are respectively an ambient light structured for providing hospital room illumination, a reading light positioned to enable a hospital patient to read while lying in a hospital bed, and an examination light or, alternatively, a night light, each also positioned in the proximity of a hospital bed. Any of the loads 104, 105, 106 may include a ballast or any other electrical or mechanical component(s). Three switches 101, 102, 103 are connected to switch connector block 55 and are each normally-open, momentary switches. In a preferred embodiment, switches 101, 103 are packaged together as individual switches in a pillow switch box 109 attached to or tethered to a hospital bed or to an adjacent structure such as a night stand. Switch 102 is shown as a wall switch. In the illustrated exemplary configuration, load 104 may be toggled on/off using single events of wall switch 102. However, load 104 is not able to be toggled on/off by a single switch action of switches 101 or 103. Instead, when it is desired to switch loads 104, 105 using switch 101 of pillow switch box 109, a sequential switching pattern is used where the four possible states of loads 104, 105 are sequentially activated by consecutive switch actions of switch 101, as shown in the logic table of FIG. 10B. Switch 103 of pillow switch box 109 simply toggles load 106 on and off as shown in the logic table of FIG. 10C. As described above, load 104 may be toggled on/off by wall switch 102, as shown in the logic table of FIG. 10D.

Many variations may be used for implementing a desired configuration. For example, a given switch loop, rather than having a single switch, may include several momentary switches in parallel with one another. One exemplary application of such a configuration has a nursing station switch (not shown) in parallel with switch 101, so that when a patient has fallen asleep with her lights on, a nurse may step the ambient and reading lights to their off state. In a similar example, nurse's switch(es) may be wired in series with switches 101, 103 of pillow switch box 109 to prevent a patient from changing the state of a light, such as when a patient is delirious, a mischievous child, etc. Yet another exemplary application of a ‘parental’ type control is the implementation of a timer, delay, or ‘mischief logic’ in the program code of microcontroller 70, so that a rapid toggling of wall switch 102 by the hypothetical mischievous child does not cause a corresponding rapid application of high voltage to load 104 but, rather, prevents such reaction, for example, by recognizing such a switch pattern using a pattern recognition algorithm for detecting the mischief logic, by preventing the input of a second or subsequent input switch event for a time-out period, or by delaying the actual high voltage switching event while continuously monitoring for and disabling a subsequent input switch event. In addition, microcontroller 70 has a memory that is immune from power loss. For example in the event of a power loss, processor 70 remembers the last state of operation of LVC 100 and returns back to that state when the line power returns.

In a further example for implementing various features of PIC controller 70, a PIC program may provide combinatorial logic for entering a calibration or configuration mode, or for other reasons. In one exemplary method, a user may press and hold down two switches at a time for at least a predetermined time, and then press and hold down only one switch for a second predetermined time. Upon detecting such switch events, PIC processor 70 enters a configuration mode whereby the user can select a different logic version to be implemented by the LVC. For example, the user may step between several optional programs by continued pressing of one switch, and may check to see which program is currently selected by pressing, for example, the second switch of a pillow switch box. When indicating the particular logic version that is currently selected, PIC 70 in this example causes a reading light of load 105 to be quickly energized a number of consecutive times, i.e., the light is flashed twice, indicating the second pre-programmed logic routine is currently selected. If this second logic is what the user desires as her selection, the user holds down both buttons 101, 103 for two seconds, thereby locking-in the second logic into PIC 70 and exiting the configuration mode. Many other modes may be implemented according to various switch schemes.

FIG. 8 is a highly schematic view of circuit board 20 which illustrates another important design consideration for uniquely packaging an LVC into a case having the dimensions of a standard electronic ballast, where an AC line voltage is being input to a first end 1 of circuit board 20, where an AC high voltage is controllably switched as an output at an opposite end 2 of circuit board 20, and where a DC low voltage circuit is clustered in a middle portion 3 of circuit board 20. The clustering of components of the DC low voltage section 3 acts, for example, to isolate hazardous high voltage spikes (e.g., high voltages at relay contacts) from a patient operating the remote external switch(es). In addition, the use of high-speed switching diodes acts to prevent high voltage from damaging the microcontroller 70. Such design considerations relate to compliance with regulatory specifications such as those imposed by Underwriter's Laboratory (UL) and others related to safety concerns and the like for remote switches used by a hospital patient from her hospital bed. For example, switch(es) located at the hospital bed are required to operate at a DC low voltage and such DC low voltage is supplied to and received from the switch by the low voltage DC control circuit is clustered in a middle portion 3 of circuit board 20. Such low voltage DC control circuit is required to have a minimum distance from any adjacent high voltage. Therefore, because the total circuit board area or footprint used by the various components leaves no room for passing high voltage from end 1 to end 2 via middle section 3, the present inventors have provided a parts layout combination that maintains the required ‘safety barrier’ between the low voltage components in middle portion 3 and the high voltage. In particular, a hot wire 40 is provided to pass the high voltage from end 1 to end 2, thereby bypassing middle portion 3. In addition, the various other incremental novel design combinations provide the desired LVC functionality in a package having the same dimensions as an electronic ballast.

All components of LVC 10 are chosen for maximizing the efficiency of space on circuit board 20. As a result, in the low voltage section all the various resistors, capacitors, diodes, transistors, microcontroller, and rectifier bridge are preferably surface mount type devices. Even filter capacitor 28 is preferably chosen with a surface mount base, such an exemplary filter capacitor having an industry part number EEVFK1E222M or equivalent. An exception is MOV 26, which preferably has a traditional twin lead form.

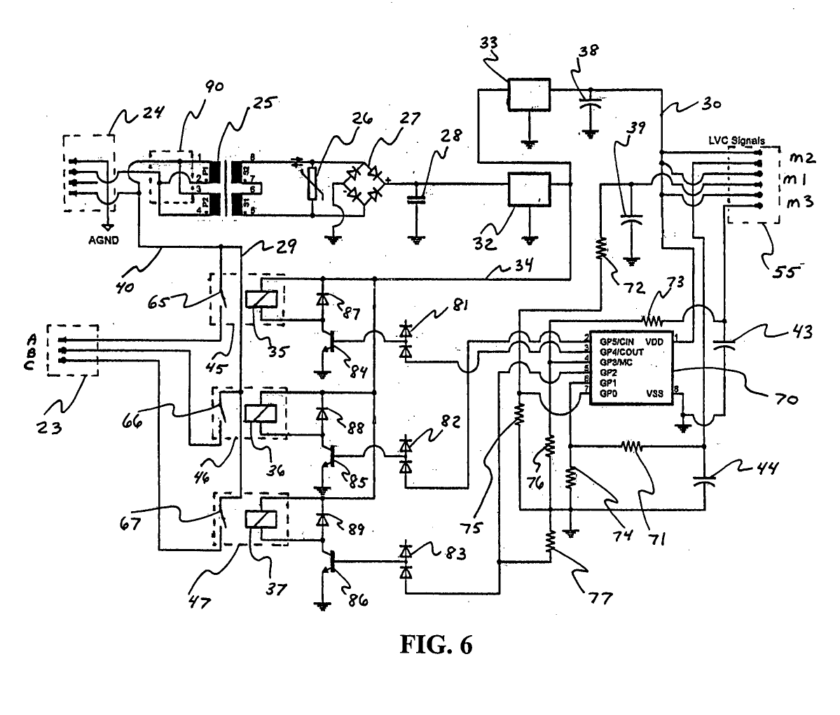

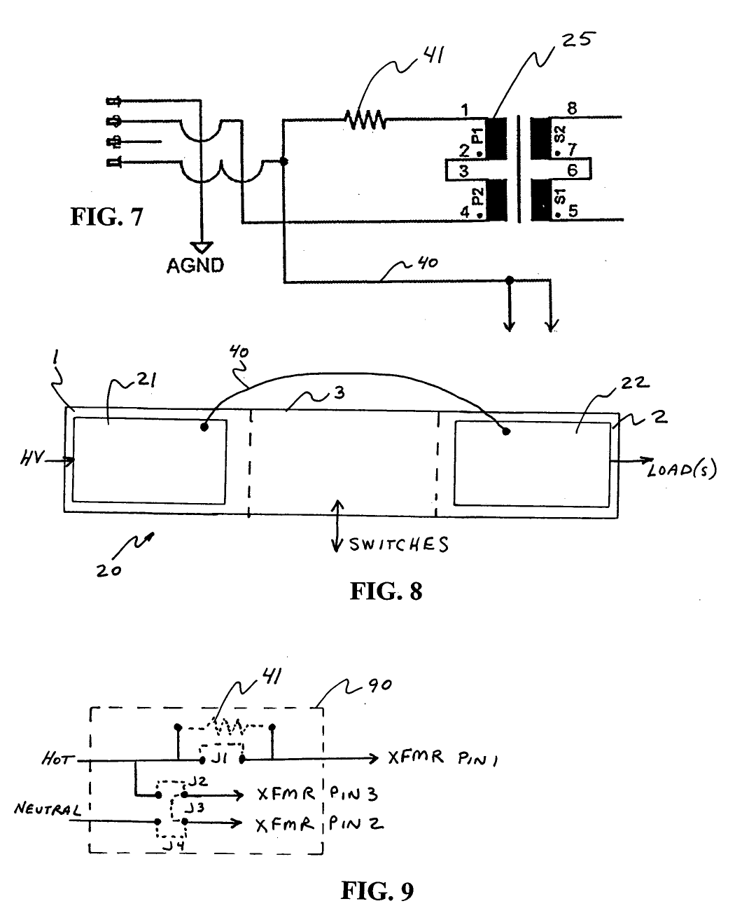

The circuit schematic of FIG. 6 may be adapted for use with a 277 VAC line voltage by implementing the configuration of FIG. 7, either by use of a separate printed circuit board for the 277 VAC version, or by use of an on-board adapter such as that shown by example in FIG. 9. When the AC high voltage is 277 VAC, a voltage reducing resistor 41 is added in series with the hot lead, upstream of a primary side of transformer 25, for reducing the 277 VAC to a voltage of about 230 VAC. This is important because 277 VAC is a commonly used lighting voltage and it is desirable to input the 277 VAC to LVC 10, both for operation of LVC 10 and for switching 277 VAC through LVC 10 to lighting ballast load(s). Resistor 41 is also important because the tight packaging requirements of LVC 10 include a low profile, and maintaining such low profile is difficult when stepping-down 277 VAC compared with 230 VAC because transformer 25 becomes too large in size. Specifically, when a resistor 41 is used to dissipate approximately 47 VAC, a 230 VAC to AC low voltage voltage reduction may be accomplished with a smaller step-down transformer, compared with a 277 VAC to AC low voltage voltage reduction, thereby allowing a low profile transformer to be used. In a preferred embodiment, resistor 41 is a metal oxide resistor with a value of 2.2K ohms and a power rating of 3 watts. It is noted that the full 277 VAC is switched to the load(s) because resistor 41 is used only in series with the high voltage being supplied to transformer 25. Therefore, the power consumption of the low voltage portion 31 essentially only varies appreciably with the number of relay coils 35, 36, 37 currently being activated, and the resultant current through resistor 41 remains within a fairly small window.

In FIG. 9, a configuration section 90 is shown as an example of an on-board arrangement that allows a single version of a printed circuit board to be used for any chosen line voltage, for example 120, 230, 240, or 277 VAC. In this example, when the line voltage is 277 VAC, resistor 41 is installed and jumper J1 is omitted. When the input voltage is not 277 VAC, resistor 41 is not installed and jumper J1 is inserted to pass the input voltage directly to transformer 25. When the input voltage is 120 VAC, jumper J2 is installed to connect the AC hot line to both of pins 1 and 3 of transformer 25, as shown in FIG. 6. In addition, for 120 VAC, jumper J4 is inserted to pass the AC neutral line to pin 2 of transformer 25. When the AC line voltage is 230/240 VAC, only jumper J3 (and jumper J1) is installed, so that the 230/240 VAC is presented across transformer pins 1 and 4, with pins 2 and 3 of transformer 25 being connected.

Since a given installation may require compliance with UL high voltage spacing regulations, a configurable selector 90 may not be available in all applications. In such a case, different circuit boards versions may be used for the respective different high voltages, rather than configuring a universal circuit board. It is noted that an additional possibility, for addressing the relative spacing between a high voltage location within the LVC and an adjacent lower-potential structure, involves the use of potting compounds and the like. For example, by encasing selected components of the circuit board with a potting resin or other suitable sealant, it is possible to satisfy the UL specifications in a small package.

Any appropriate electrical load may be switched on/off by use of a low voltage controller according to the invention. For example, lighting fixtures may or may not include ballasts and loads may be unrelated to lighting fixtures, such as in an application for low voltage switching of high voltage to appliances, etc. As noted above, the horsepower rating of the relay(s) of the LVC should be confirmed to be adequate for the chosen load.

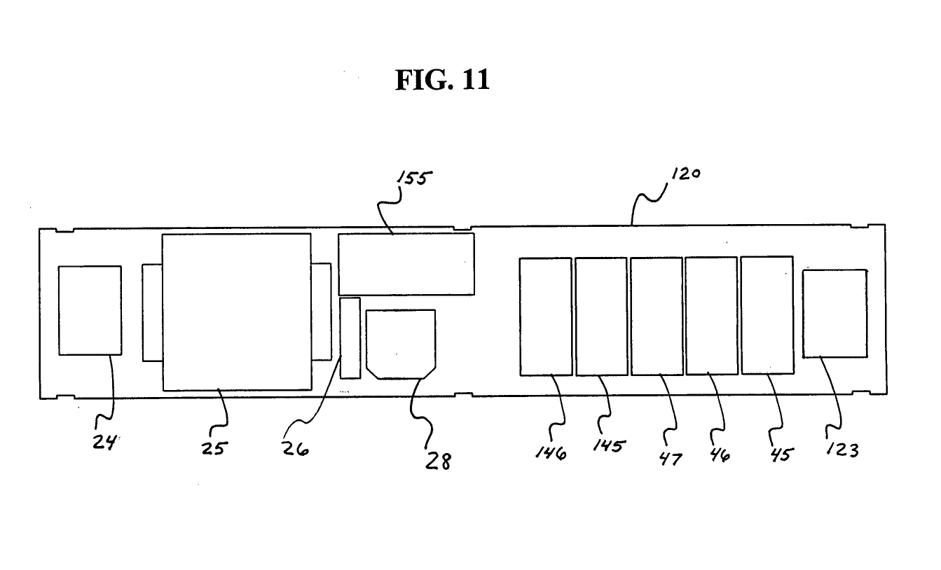

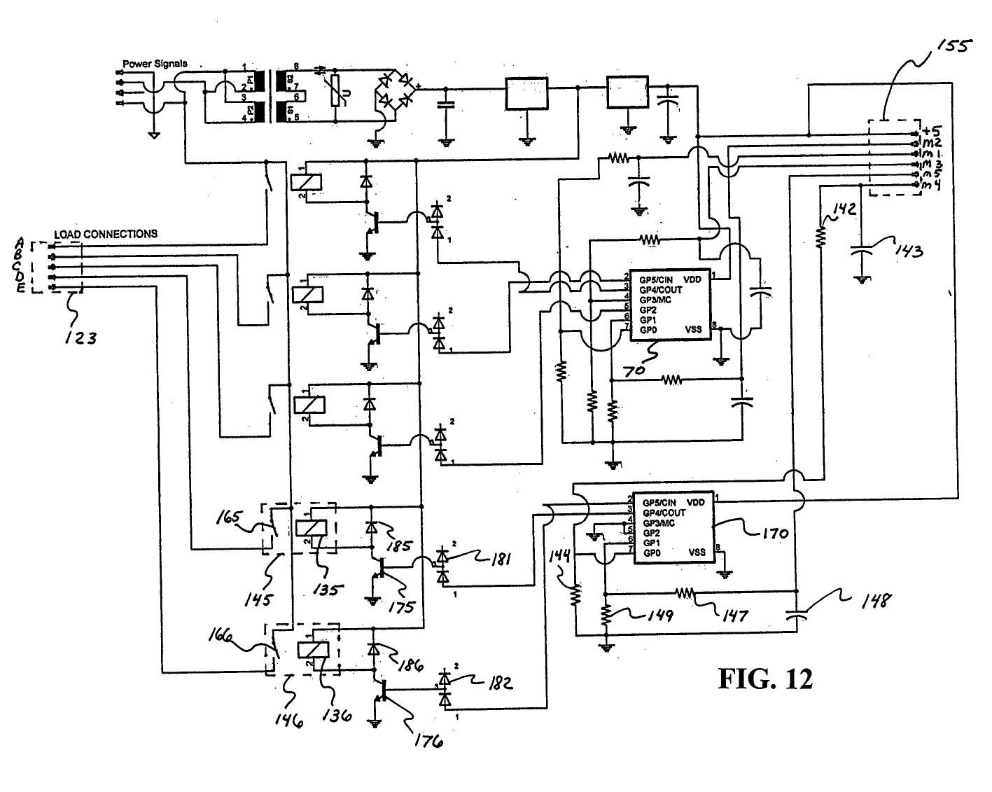

FIG. 11 is a top view and FIG. 12 is a circuit schematic of an LVC circuit board 120 according to another exemplary embodiment. Circuit board 120 has five relays 45, 46, 47, 145, 146 for on/off switching of high voltage to five corresponding external loads A-E. In this example, five external switches M1-M5 are connected to individual terminals of switch terminal block 155. A +5 VDC voltage is fed to switches M1-M5 by a single terminal of switch terminal block 155. This differs from other embodiments that separately feed +5 VDC to pairs of leads for each switch, from a circuit board. By using the single +5 VDC common terminal, more switches can be accommodated by the same number of individual terminal connections. It is understood that the +5 VDC common lead of switch terminal block 155 is fed to the individual external switches M1-M5 at a location external to PCB 120, such as in a pillow switch.

The switching of loads A-C is effected using a first microprocessor 70 as described above and in FIG. 6. A second microprocessor 170 is used in the FIG. 12 circuit for the on/off switching of loads D and E. Relay coils 135, 136 are each provided with a respective diode 185, 186 in parallel, and are each activated with a respective relay driver transistor 175, 176. Diodes 185, 186 may be, for example, an industry part number DL4003MSCT or equivalent, and driver transistors 175, 176 are preferably NPN general purpose switching transistors such as an industry part number MMBT3904 or equivalent. Diodes 181, 182 are respectively provided between the individual switch outputs GP0, GP1 of microprocessor 170 and the corresponding bases of driver transistors 175, 176, assuring that the turn-on voltage for such transistors is at a predetermined level. A suitable diode device for such application has an industry part number MMBD914. Activation of relay coils 135, 136 respectively closes the normally-open relay contacts 165, 166 of relays 145, 146. Accordingly, relays 145, 146 may be referred to herein simply as switches S4 and S5, respectively. Closure of S4 and/or S5 passes the AC high voltage from AC high voltage buss 29 as respective load signals D and/or E to external loads.

A capacitor 143 is connected between the M4 terminal and ground to assure that the switch input to the GP0 pin of microprocessor 170 is immune from noise. A biasing resistor 144 is connected between pin GP0 and ground to provide additional stability and a suitable voltage level to the microprocessor switch input. The combination of resistors 142 and 144, the impedance of the external M4 switch loop, and the input impedance of the GP0 connection establishes the nominal 200 mA M4 switch loop current at 5 VDC. A capacitor 148 is connected between the M5 terminal and ground to assure that the switch input to the GP1 pin of microprocessor 170 is immune from noise. A biasing resistor 147 is connected between pin GP1 and ground to provide additional stability and a suitable voltage level to the microprocessor switch input. The combination of resistors 147 and 149, the impedance of the external M5 switch loop, and the input impedance of the GP1 connection establishes the nominal 200 mA M5 switch loop current at 5 VDC.

Microcontroller 170 in a preferred embodiment is a Programmed Integrated Circuit (PIC) available from Microchip Technology, Inc. and has a part number PIC12F629ISN. This is the same PIC chip specified above for microprocessor 70. The only difference in application to FIG. 12 is that one set of I/O pins of microprocessor 170 are grounded since microprocessor 170 is only controlling the on/off switching of two loads. Of course, each PIC chip 70, 170 may be separately programmed to implement different logic. In a preferred embodiment, no combinatorial logic is used and there is a direct switching of loads A-E by respective switch inputs S1-S5.

In other embodiments, an LVC circuit board may utilize a wireless interface, instead of hard-wired switches (e.g., switch loops M1-M5), for receiving control inputs. Such a wireless interface may utilize either optical or RF transmission of control signals from a remote controller (not shown). Such a wireless interface is constrained by space limitations necessitated by the desired packaging within an LVC case 50 having the same general dimensions as an electronic ballast. When a wireless interface utilizes an optical signal transmission scheme, it includes a radiation receiver that must be positioned within a lighting fixture for its illumination from a range of locations within a room. When a wireless interface is an RF circuit, there is no need to have a line-of-sight between a transmitter and the receiving section of the wireless interface circuit.

While the principles of the invention have been shown and described in connection with specific embodiments, it is to be understood that such embodiments are by way of example and are not limiting. Consequently, variations and modifications commensurate with the above teachings, and with the skill and knowledge of the relevant art, are within the scope of the present invention. The embodiments described herein are intended to illustrate best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A low voltage controller comprising:
a circuit board having first and second lengthwise ends and having a high voltage input proximate the first end and a high voltage output proximate the second end, the high voltage input adapted for receiving an AC high voltage;
a voltage conversion circuit disposed on the circuit board between the first and second ends and including a step-down transformer, the voltage conversion circuit being structured for converting the AC high voltage to at least one DC low voltage;
a power terminal;
at least one load switch disposed on the circuit board and activated by use of the at least one DC low voltage for controllably switching the AC high voltage from the power terminal to a first output of the high voltage output; and
a hot wire providing an electrical connection for transferring the AC high voltage from the high voltage input to the power terminal.

2. The low voltage controller of claim 1 further comprising a control circuit disposed on the circuit board and adapted for connection to an external control switch, the control circuit structured for controlling operation of the load switch based on operation of the external control switch.

3. The low voltage controller of claim 2 further comprising the external control switch, the external control switch being adapted for DC low voltage operation.

4. The low voltage controller of claim 2 structured for controllably switching the AC high voltage from the power terminal to a second output of the high voltage output, wherein the control circuit is adapted for implementing state logic for the switching of the AC high voltage to the first and second outputs.

5. The low voltage controller of claim 4 wherein the high voltage output includes a third output and wherein the control circuit is adapted for implementing state logic for controllably switching the AC high voltage to any combination of the first, second, and third outputs.

6. The low voltage controller of claim 2 structured for controllably switching the AC high voltage from the power terminal to a second output of the high voltage output, wherein the control circuit is adapted for implementing combinatorial logic for the switching of the AC high voltage to the first and second outputs.

7. The low voltage controller of claim 1 wherein the control circuit is structured for obtaining an override signal and is programmable for disabling the load switch when the override signal is obtained.

8. The low voltage controller of claim 7 wherein the control circuit includes a timer for re-enabling the load switch after a predetermined time.

9. The low voltage controller of claim 1 wherein the voltage conversion circuit includes a filter capacitor and at least one voltage regulator.

10. The low voltage controller of claim 1 further comprising a resistor for obtaining a reduced AC voltage from the high voltage input and feeding the reduced AC voltage to a primary side of the step-down transformer.

11. The low voltage controller of claim 10 wherein the resistor comprises a metal oxide resistor disposed in series between the high voltage input and the step-down transformer.

12. The low voltage controller of claim 1 wherein the step-down transformer has an AC low voltage secondary voltage.

13. The low voltage controller of claim 1 wherein the high voltage input includes a high voltage input connector, the low voltage controller further comprising a case for enclosing the circuit board and hot wire, the case having an input opening adapted for accessing the high voltage input connector.

14. The low voltage controller of claim 13 wherein the case includes an input end face angled to provide both horizontal and vertical access to the high voltage input connector.

15. The low voltage controller of claim 14 wherein the high voltage input connector does not extend outside the case.

16. The low voltage controller of claim 1 wherein the high voltage output includes a high voltage output connector, the low voltage controller further comprising a case for enclosing the circuit board and hot wire, the case having an output opening adapted for accessing the high voltage output connector.

17. The low voltage controller of claim 16 wherein the case includes an output end face angled to provide both horizontal and vertical access to the high voltage output connector.

18. The low voltage controller of claim 17 wherein the high voltage output connector does not extend outside the case.

19. The low voltage controller of claim 1 wherein the circuit board has top and bottom component placement surfaces, the low voltage controller further comprising a case for enclosing the circuit board and hot wire, the case having a bottom plate, an insulating layer disposed on a top surface of the bottom plate, and a top cover adapted to be snugly secured to the bottom plate along a perimeter thereof, and wherein the insulating layer is structured for electrically insulating the bottom component surface of the circuit board from the bottom plate.

20. The low voltage controller of claim 1 further comprising a remote control input for obtaining a signal representing an external selection event, and a sequencer that receives the signal and steps the load switching according to a state program.

21. The low voltage controller of claim 20 wherein the sequencer is structured for being user-programmable.

22. A low voltage controller for switching a high voltage load comprising:
a case having approximate dimensions of 9.5 inches overall length, 1.72 inches width, and 1.14 inches height, the case having a mounting location proximate each lengthwise end and an approximate distance of 8.91 inches between the mounting locations;
a circuit board disposed within the case;
an input for receiving a first AC high voltage;
a step-down transformer mounted on the circuit board and structured for stepping a second AC high voltage down to an AC low voltage, the second AC high voltage being obtained from the first AC high voltage;
a voltage converter mounted on the circuit board and operative to convert the AC low voltage to a DC low voltage;
a relay for on/off switching of the first AC high voltage to an external load; and
a control circuit powered by the DC low voltage, having a control input structured for obtaining a DC low voltage control signal, and structured for controlling the on/off switching of the relay based on the DC low voltage control signal.

23. The low voltage controller of claim 22 further comprising a voltage-dissipating resistor disposed in series between the first and second AC high voltages, wherein the first AC high voltage is approximately 277 VAC, the second AC high voltage is approximately 230 VAC, and a voltage being dissipated across the voltage-dissipating resistor is approximately 47 VAC.

24. The low voltage controller of claim 22 wherein the case includes an input end face angled to provide both horizontal and vertical access to the input.

25. The low voltage controller of claim 22 further comprising a high voltage output connector for connecting the relay to the external load, wherein the case includes an output end face angled to provide both horizontal and vertical access to the high voltage output connector.

26. The low voltage controller of claim 22 further comprising a voltage selector for configuring the input according to a particular voltage being used as the first AC high voltage.
